(19) United States
(12) Patent Application Publication
(10) Pub. No.: US 2005/0013432 A1
(43) Pub. Date: Jan. 20, 2005

(54) Hybrid circuit for bidirectional frequency division multiplexed communication

(75) Inventor: Rudi Verbist, Mechelen (BE)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/767,816

(22) Filed: Jan. 30, 2004

Related U.S. Application Data
(60) Provisional application No. 60/487,944, filed on Jul. 18, 2003.

(51) Int. Cl. H04M 1/00; H04M 9/00

(52) U.S. Cl. 379/402

(57) ABSTRACT

The present invention relates to a hybrid circuit for bidirectional communication over a communication line, the hybrid circuit directing a transmit signal inputted at an input line to the communication line and directing a receive signal received on the communication line to an output line different to the input line, the input line and the output line being coupled with a primary side of a transformer, the secondary side of the transformer being coupled with the communication line. Optionally, the hybrid circuit can be used within a communication system for a digital subscriber line. The primary side of the transformer comprises two coils with a first terminal and a second terminal respectively, the coils being connected in series via a middle impedance arranged between the first terminals of the coils. The input line is coupled with the second terminals of the coils, wherein a first output terminal of the output line is connected via a first impedance to a first terminal of the input line and via a second impedance to the first terminal of the second coil and a second terminal of the output line is connected via a third impedance to the second terminal of the input line and via a fourth impedance to the first terminal of the first coil. With this configuration the number of required components can be reduced which is a cost and size advantage. Furthermore the present invention has the advantage to reduce the attenuation of the receive signal in the hybrid circuit.

### CROSS REFERENCE TO RELATED APPLICATIONS

This application claims the benefit of U.S. Provisional Application No. 60/487,944 filed Jul. 18, 2003, the contents of which is hereby incorporated by reference.

### BACKGROUND OF THE INVENTION

The present invention generally relates to communication systems for bidirectional frequency division multiplexed communication. The present invention relates more particularly to a hybrid circuit for bidirectional communication systems, a transceiver using a hybrid circuit, and methods related thereto and used therewith.

Traditionally a hybrid circuit is used in bidirectional frequency division multiplexed communication systems to split a transmit signal and a receive signal both being transmitted over a common communication line.

One known solution for a hybrid circuit is depicted in FIG. 2 and uses a transformer with a primary side 14, 15 and a secondary side 17, 18 the communication line 2 being connected to the secondary side 17, 18 of the transformer. The primary side of the transformer in this solution is divided in two coils 14, 15 which are connected in series via a middle impedance 13. In transmission direction an input line 3 for inputting the transmit signal is connected via two transmission impedances 23, 24 to the coils 14, 15 of the primary side first terminals of the transmission impedances 23, 24 being connected to the terminals 5, 6 of the input line 3 and second terminals of the transmission impedances 23, 24 being connected to the coils 14, 15.

In receiving direction an output line 4 for outputting the received receive signal is provided. In order to separate the transmit signal from the received receive signal a first terminal 7 of the output line 3 is connected via a first impedance 9 to the first terminal of the first transmission impedance 23 and via a second impedance 11 to the second terminal of the second transmission impedance 24. A second terminal 8 of the output line 3 is connected via a third impedance 10 to the first terminal of the second transmission impedance 24 and via a fourth impedance 12 to the second terminal of the first impedance 23. In order to increase the level of the receive signal the transmission impedances 23, 24 which terminate the communication line 3 are normally chosen to match the impedance of the communication line 3 taking into account the turns ratio of the transformer. This hybrid circuit has the disadvantage that half of the power delivered with the transmit signal is dissipated in the transmission impedances 23, 24. Furthermore the required capacitors for the impedances have high values and therefore are disadvantageous regarding cost and size.

The present invention solves the aforementioned exemplary problems, and/or other problems in the art, and provides a hybrid circuit with reduced signal power requirements, high signal power of the receive signal and reduced cost and size.

### BRIEF SUMMARY OF THE INVENTION

The present invention relates to a hybrid circuit for bidirectional communication over a communication line. The hybrid circuit directs a transmit signal inputted at an input line to the communication line and directs a receive signal received on the communication line to an output line different to the input line, the input line and the output line being coupled with a primary side of a transformer, the secondary side of the transformer being coupled with the communication line and the primary side of the transformer comprising two coils with a first terminal and a second terminal respectively, the coils being connected in series via a middle impedance arranged between the first terminals of the coils and the input line being coupled with the second terminals of the coils, wherein a first output terminal of the output line is connected via a first impedance to a first terminal of the input line and via a second impedance to the first terminal of the second coil and a second terminal of the output line is connected via a third impedance to the second terminal of the input line and via a fourth impedance to the first terminal of the first coil. The first impedance optionally is equal to the third impedance. Furthermore the second impedance optionally is equal to the fourth impedance.

In a first variant a first terminal of the input line is coupled via a fifth impedance with the second terminal of the first coil and a second terminal of the input line is coupled via a sixth impedance with the second terminal of the second coil. The fifth impedance optionally is equal to the sixth impedance.

In another variant the first terminal of the input line is coupled via a seventh impedance with the first impedance and the second terminal of the first coil and the second terminal of the input line is coupled via an eighth impedance with the third impedance and the second terminal of the second coil. The seventh impedance in a variant is optionally equal to the eighth impedance.

Furthermore it is conceivable that the magnitude of the middle impedance is substantially smaller than the magnitude of the first and third impedance, or the second and fourth impedance, or the first, second, third and fourth impedance.

In a preferred embodiment the receive signal is received in a receiving frequency range and the impedance value of the middle impedance in the receiving frequency range is substantially identical to the complex conjugate of the communication line impedance in the receiving frequency range taking into account the transforming ratio of the transformer.

In yet another variant the receive signal is received in a receiving frequency range and the impedance value of the serial combination of the middle impedance, the fifth impedance and the sixth impedance in the receiving frequency range is substantially identical to the complex conjugate of the communication line impedance in the receiving frequency range taking into account the transforming ratio of the transformer.

In a further variant the receive signal is received in a receiving frequency range and the impedance value of the serial combination, of the middle impedance, the seventh impedance and the eighth impedance in the receiving frequency range is substantially identical to the complex conjugate of the communication line impedance in the receiving frequency range taking into account the transforming ratio of the transformer.

These and other advantages, aspects and novel features of the present invention, as well as details of illustrated examples, are more fully understood from the following description and drawings.

### BRIEF DESCRIPTION OF THE DRAWINGS/FIGURES

FIG. 1 illustrates a schematic block diagram of a hybrid circuit used in a transceiver for bidirectional full duplex frequency division multiplexed communication.

FIG. 2 illustrates a contemporary hybrid circuit according to the prior art.

FIG. 3 illustrates an exemplary hybrid circuit in accordance with an embodiment of the present invention.

FIG. 4 illustrates an exemplary hybrid circuit according to a second embodiment of the present invention.

FIG. 5 illustrates an exemplary hybrid circuit according to a third embodiment of the present invention.

### DETAILED DESCRIPTION OF THE INVENTION

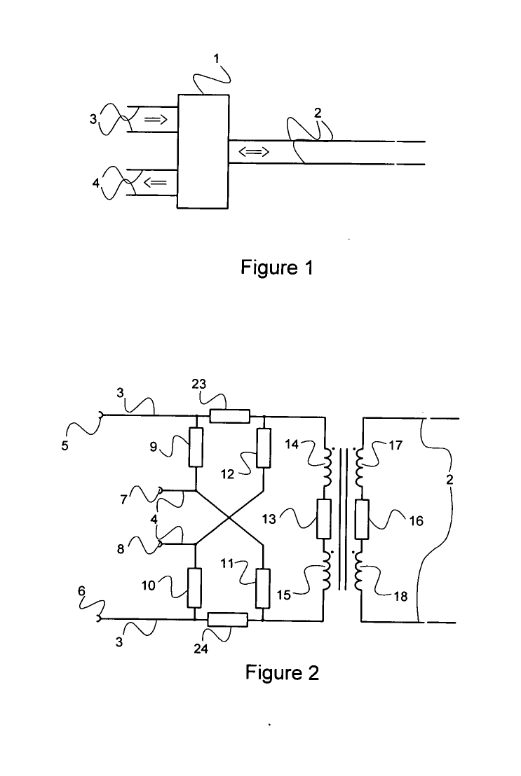

FIG. 1 illustrates a schematic block diagram of hybrid circuit 1 for use in a bidirectional frequency division multiplexed communication system in which a transmit signal transmitted from the hybrid circuit 1 and a receive signal received by the hybrid circuit 1 is transmitted over a common communication line 2. Both signals are split so that the receive signal is outputted via an output line 4 and the transmit signal is inputted via an input line 3. This is also called 4 wire/2 wire conversion. The communication line 2 has a communication line impedance which attenuates the transmitting signal and the receive signal.

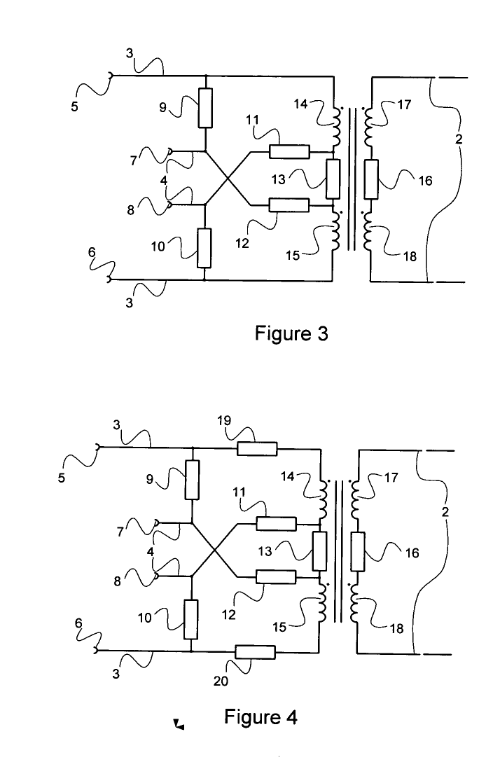

In FIG. 3 a hybrid circuit 1 according to a first embodiment of the present invention is outlined. The hybrid circuit 1 comprises an input line 3 with two terminals 5, 6 and an output line 4 with two terminals 7, 8 and directs a transmit signal inputted at the input line 3 to the communication line 2 and directs a receive signal received over the communication line 2 to the output line 4. The shown hybrid circuit is part of a transceiver. The communication line 2 is, by way of example, a twisted pair line used for a digital subscriber line.

The hybrid circuit 1 uses a transformer with a primary side comprising two coils 14, 15 and being inductively coupled to a secondary side comprising two coils 17, 18. The coils 17, 18 of the secondary side are connected in series via a connecting impedance 16 and are connected with their terminals opposed to the connecting impedance 16 to the communication line 2. The communication line 2 is displayed only partially and leads to another transceiver which optionally comprises also a hybrid circuit according to the present invention.

On the primary side of the transformer each coil 14, 15 comprises a first terminal. The first terminal of the first coil 14 and the first terminal of the second coil 15 are connected to opposed terminals of a middle impedance 13. By way of the middle impedance 13 the two coils 14, 15 are connected in series. Furthermore the two coils 14, 15 comprise second terminals opposed to their first terminals.

The terminals 5, 6 of the input line 3 are connected to the second terminals of the coils 14, 15. The inputted transmit signal passes a serial combination of the middle impedance 13 and the coils 14, 15.

The output line 4 comprises a first terminal 7 and a second terminal 8. The first terminal 7 of the output line 4 is connected via a first impedance 9 to the first terminal 5 of the input line 3 and via a second impedance 12 to first terminal of the second coil 15. The second terminal 8 of the output line 4 is connected via a third impedance 10 to the second terminal 6 of the input line 3 and via a fourth impedance 11 to the first terminal of the first coil 14. With this arrangement it is achieved that the transmit signal inputted at the input line 3 is attenuated in the receive signal outputted at the output line 4.

The termination of input line 3 is influenced by the middle impedance 13. The same applies in the other direction for the communication line 2 which substantially is terminated by the middle impedance 13 taking into account the transforming ratio of the transformer.

In order to receive the receive signal with the highest possible level the communication line 2 should be terminated with an impedance substantially equal to the complex conjugate of the impedance of the communication line 2. Thus in the present embodiment the middle impedance 13 is arranged to approach the complex conjugate of the impedance of the communication line 2 taking into account the transforming ratio of the transformer and the impedances of the connecting impedance 16 and of the transformer. If the connecting impedance 16 as well as the impedance of the transformer are nearly transparent in the receive signal frequency band then the connecting impedance 16 and the transformer's impedance can be disregarded regarding the value of the middle impedance 13 for matching the transmission line 2. If in such a case ZC* is the complex conjugate of the impedance of the communication line 2 and 1:N is the turns ratio of the transformer, i.e. the coils 14, 15 of the primary side and the coils 17, 18 of the secondary side, an advantageous value Z for the middle impedance 13 is as follows:
Z=ZC*/N²

Compared with the known hybrid circuit of FIG. 2 the number of required components and thereby costs could be reduced, since the three impedances 13, 23, 24 in the known hybrid circuit of FIG. 2 get replaced by only one impedance 13 in the inventive hybrid circuit of FIG. 3.

In order to adapt the hybrid circuit 1 according to the first embodiment of the present invention to approach the electrical characteristics of the known hybrid circuit depicted in FIG. 2 the following transformation can be used.

Assuming that the two transmission impedances 23, 24 of the known hybrid circuit are parallel combinations of a resistor R′1 and a capacitor C′1 and that the middle impedance 13 of the known hybrid circuit is a capacitor C′2 the middle impedance 13 for the hybrid circuit 1 of the present invention can be a parallel combination of a capacitor C2 and a serial combination of a resistor R1 and a capacitor C1. The values for the capacitors C1 and C2 and the resistor R1 can be determined as follows:
C1=2*(C′2)²/(C′1+2*C′2)
C2=C′2−C1
R1=R′1*(C′1+2*C′2)²/2/C′2²

From these equations it can be derived that the values of C1 and C2 are smaller than of C′2 of the known hybrid circuit which is a cost and size advantage. R1 has a greater value than R′1 in the known hybrid circuit, but that is no disadvantage since cost and size of a resistor in independent on its value.

The middle impedance 13 has influence over the level of the receive signal by matching the impedance of the communication line 2 and furthermore over the power consumption for transmitting the transmitting signal. In order to reduce the power consumption for the signal transmission the impedance value should approach zero. Since in frequency division multiplexed communication systems the transmit signal is transmitted in a frequency range different to that of the receive signal the middle impedance 13 can be arranged according to the abovementioned equations in the receiving frequency range and at the same time can be arranged to approach zero or a substantially reduced value in the transmission frequency range. If the transmit signal frequency range lies above the receive signal frequency range this can be achieved by using one or more capacitors.

For this purpose some lower order implementations can be conceived for the middle impedance 13. In a first implementation the middle impedance 13 is a simple resistor, in a second implementation a serial combination of a resistor and a capacitor, in a third implementation a parallel combination of a resistor and a capacitor and in a fourth implementation a capacitor. From the first to the fourth implementation the ability to match the communication line impedance decreases which reduces the received receive signal and at the same time the power consumption for the transmission of the transmit signal is reduced which is an advantage.

In order to make the embodiment depicted in FIG. 3 equivalent to the known hybrid circuit depicted in FIG. 2 regarding the transmission of the receive signal from the communication line 2 to the output line 4 the following adaptations can be carry out. If in the hybrid circuit of FIG. 3 according to the present invention the second impedance 12 and the fourth impedance 11 are ZB, the first impedance 9 and the third impedance 10 are ZA and the middle impedance 13 is ZC and if in the known hybrid circuit of FIG. 2 the transmission impedances 23, 24 are Z1, the first impedance 9 and the third impedance 10 are Z2 and the middle impedance 13 is Z4 then an equivalence between the known hybrid circuit of FIG. 2 and the inventive hybrid circuit of FIG. 3 can be achieved as follows.
ZB=ZA*Z4/2/Z1
Z2→∞
ZA+ZB>>ZC

The condition ZA+ZB>>ZC is exactly what is desired in order to reduce the power dissipation for the transmission of the transmit signal. However the condition Z2→∞ is not acceptable for the known hybrid circuit of FIG. 2 since in this case the circuit does not work as hybrid circuit. Thus the hybrid circuit 1 of FIG. 3 according to the present invention contains less attenuation of the receive signal which is an advantage of the present invention compared with the known hybrid circuit of FIG. 2 which has some attenuation of the receive signal in the branches formed by the first and second impedances 9, 11 and the third and fourth impedance 10, 12.

Often the middle impedance 13 is a capacitor. If in this case the transmission impedances 23, 24 of the known hybrid circuit of FIG. 2 and the first and the third impedance 9, 10 of the inventive hybrid circuit of FIG. 3 are purely resistive, the equation ZB=ZA*Z4/2/Z1 shows that the second and fourth impedance 12, 11 of the inventive hybrid circuit of FIG. 3 become also capacitors, but with the factor ZA/2/Z1 smaller than the capacitance value of the middle impedance 13. Since ZA can be chosen freely, this allows the use of very small capacitor values which means an advantage regarding cost and size for the hybrid circuit according to the present invention.

Now the case in which the middle impedance 13→∞ is taken into consideration. In this case the transmission function from the communication line 2 to the output line 4 for the inventive hybrid circuit of FIG. 3 is identical to that of the known hybrid circuit if the following equations are met if the first and the third impedance 9, 10 of the inventive hybrid circuit of FIG. 3 are ZA, the transmission impedances 23, 24 of the known hybrid circuit of FIG. 2 are Z1, the second and fourth impedance 12, 11 of the inventive hybrid circuit of FIG. 3 are ZB and the middle impedance 13 of the known hybrid circuit of FIG. 2 is Z4.
ZA=Z1
ZB=Z4/2
Z2→∞

The latter condition shows again the reduced signal loss for the receive signal in the hybrid circuit according to the present invention. For the transmission of the transmitting signal the power dissipation is the same compared with the known hybrid circuit, but in the known hybrid circuit of FIG. 2 the output voltage of an amplifier for providing the transmit signal will need to be higher whereas in the inventive hybrid circuit of FIG. 3 the current of the amplifier will need to be higher. This can be an advantage for the inventive hybrid circuit if the supply voltage for the amplifier is limited. Such a limitation often occurs, due to the technology used to implement the amplifier or some additional system constraints, like for example the use of an Universal Serial Bus (USB), where a single +5 Volt supply is standard.

In FIG. 4 a further embodiment of the inventive hybrid circuit is shown. In this embodiment a fifth impedance 19 is introduced between the connection of the first input terminal 5 of the input line 3 and the first impedance 9 and the second terminal of the first coil 14. Furthermore a sixth impedance 20 is introduced between the connection of the second terminal 6 of the input line 3 and the third impedance 10 and the second terminal of the second coil 15. In a preferred embodiment the fifth and the sixth impedance 19, 20 are equal.

The addition of the fifth and sixth impedance 19, 20 not being zero can be useful if for example the communication line 2 can be subject to voltage/current excesses, like power cross and surge pulses and if the amplifier for supplying the transmit signal has no sufficient built-in protection. By selecting for example a very small resistor value for the fifth and the sixth impedance 19, 20 the amplifier can be protected better. In addition extra protection elements, like diodes, zener diodes, schottky diodes, varistors or other transient suppression devices may be added to obtain full protection under all conditions, required for a specific application.

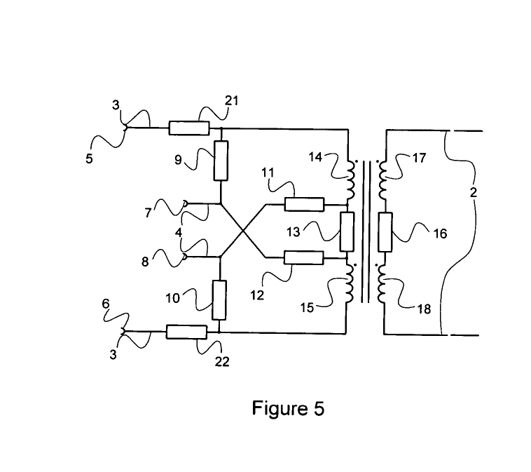

In FIG. 5 a further embodiment of the present invention similar to the embodiment of FIG. 4 is shown. In the embodiment of FIG. 5 there are provided a seventh impedance 21 and an eighth impedance 22 between the first and the second input terminal 5, 6 respectively and the first impedance 9 and the third impedance 10 respectively. Regarding their function the seventh and eighth impedance 21, 22 are equivalent to the fifth and sixth impedance 19, 20 of FIG. 4. Also regarding the elements usable for the realization of the seventh and eighth impedance 21, 22 the same as for the fifth and the sixth impedance 19, 20 applies.

As described above the invention provides a hybrid circuit for bidirectional communication over a communication line (2), the hybrid circuit directing a transmit signal inputted at an input (3) line to the communication line (2) and directing a receive signal received on the communication line (2) to an output line (4) different to the input line (3). The input line (3) and the output line (4) are coupled with a primary side (14, 15) of a transformer, the secondary side (17, 18) of the transformer being coupled with the communication line (2) and the primary side (14, 15) of the transformer comprising two coils (14, 15) with a first terminal and a second terminal respectively, the coils being (14, 15) connected in series via a middle impedance (13) arranged between the first terminals of the coils (14, 15). The input line (3) is coupled with the second terminals of the coils (14, 15), wherein a first output terminal (7) of the output line (4) is connected via a first impedance (9) to a first terminal (5) of the input line (3) and via a second impedance (12) to the first terminal of the second coil (15) and a second terminal (8) of the output line (4) is connected via a third impedance (10) to the second terminal (6) of the input line (3) and via a fourth impedance (11) to the first terminal of the first coil (14). Optionally the first impedance (9) is equal to the third impedance (10) and/or the second impedance (12) is equal to the fourth impedance (11).

In one variant of the hybrid circuit a first terminal (5) of the input line (3) is coupled via a fifth impedance (19) with the second terminal of the first coil (14) and a second terminal (6) of the input line (3) is coupled via a sixth impedance (20) with the second terminal of the second coil (15).

In yet another variant the first terminal (5) of the input line (3) is coupled via a seventh impedance (21) with the first impedance (9) and the second terminal of the first coil (14) and the second terminal (6) of the input line (3) is coupled via an eighth impedance (22) with the third impedance (10) and the second terminal of the second coil (15).

Optionally the fifth impedance (19) is equal to the sixth impedance (20) and/or the seventh impedance (21) is equal to the eighth impedance (22).

In a further variant the magnitude of the middle impedance (13) is substantially smaller than the magnitude of the first (9) and third (10) impedance, or the second (12) and fourth (11) impedance, or the first (9), second (12), third (10) and fourth (11) impedance.

The hybrid circuit can be configured such, that the receive signal is received in a receiving frequency range and the impedance value of the middle impedance (13) in the receiving frequency range is substantially identical to the complex conjugate of the impedance of the communication line (2) in the receiving frequency range taking into account the transforming ratio of the transformer.

If the fifth impedance (19) and the sixth impedance (20) are present and the receive signal is received in a receiving frequency range, the impedance value of the serial combination of the middle impedance (13), the fifth impedance (19) and the sixth impedance (20) in the receiving frequency range optionally is substantially identical to the complex conjugate of the impedance of the communication line (2) in the receiving frequency range taking into account the transforming ratio of the transformer.

In case the seventh impedance (21) and the eighth impedance (22) are present and the receive signal is received in a receiving frequency range the impedance value of the serial combination of the middle impedance (13), the seventh impedance (21) and the eighth impedance (22) in the receiving frequency range is substantially identical to the complex conjugate of the impedance of the communication line (2) in the receiving frequency range taking into account the transforming ratio of the transformer.

Many alterations and modifications may be made by those having ordinary skill in the art without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A hybrid circuit for bidirectional communication over a communication line, the hybrid circuit directing a transmit signal inputted at an input line to the communication line and directing a receive signal received on the communication line to an output line different to the input line, the input line and the output line being coupled with a primary side of a transformer, the secondary side of the transformer being coupled with the communication line and the primary side of the transformer comprising two coils with a first terminal and a second terminal respectively, the coils being connected in series via a middle impedance arranged between the first terminals of the coils and the input line being coupled with the second terminals of the coils, wherein a first output terminal of the output line is connected via a first impedance to a first terminal of the input line and via a second impedance to the first terminal of the second coil and a second terminal of the output line is connected via a third impedance to the second terminal of the input line and via a fourth impedance to the first terminal of the first coil.

2. The hybrid circuit of claim 1, in which a first terminal of the input line is coupled via a fifth impedance with the second terminal of the first coil and a second terminal of the input line is coupled via a sixth impedance with the second terminal of the second coil.

3. The hybrid circuit of claim 1, in which the first terminal of the input line is coupled via a seventh impedance with the first impedance and the second terminal of the first coil and the second terminal of the input line is coupled via an eighth impedance with the third impedance and the second terminal of the second coil.

4. The hybrid circuit of claim 1, in which the magnitude of the middle impedance is substantially smaller than the magnitude of the first and third impedance, or the second and fourth impedance, or the first, second, third and fourth impedance.

5. The hybrid circuit of claim 1, in which the first impedance is equal to the third impedance.

6. The hybrid circuit of claim 1, in which the second impedance is equal to the fourth impedance.

7. The hybrid circuit of claim 2, in which the fifth impedance is equal to the sixth impedance.

8. The hybrid circuit of claim 3, in which the seventh impedance is equal to the eighth impedance.

9. The hybrid circuit of claim 1, in which the receive signal is received in a receiving frequency range and the impedance value of the middle impedance in the receiving frequency range is substantially identical to the complex conjugate of the communication line impedance in the receiving frequency range taking into account the transforming ratio of the transformer.

10. The hybrid circuit of claim 2, in which the receive signal is received in a receiving frequency range and the impedance value of the serial combination of the middle impedance, the fifth impedance and the sixth impedance in the receiving frequency range is substantially identical to the complex conjugate of the communication line impedance in the receiving frequency range taking into account the transforming ratio of the transformer.

11. The hybrid circuit of claim 3, in which the receive signal is received in a receiving frequency range and the impedance value of the serial combination of the middle impedance, the seventh impedance and the eighth impedance in the receiving frequency range is substantially identical to the complex conjugate of the communication line impedance in the receiving frequency range taking into account the transforming ratio of the transformer.
